(19) United States
(12) Patent Application Publication
(10) Pub. No.: US 2017/0190282 A1
(43) Pub. Date: Jul. 6, 2017

(54) RUNNING BOARD ILLUMINATION SYSTEM AND METHOD FOR A MOTOR VEHICLE

(71) Applicant: FORD GLOBAL TECHNOLOGIES, LLC, Dearborn, MI (US)

(72) Inventors: Stuart C. Salter, White Lake, MI (US); Terrence Joseph Wilson, Southfield, MI (US); Aaron Bradley Johnson, Allen Park, MI (US)

(21) Appl. No.: 15/399,374

(22) Filed: Jan. 5, 2017

Related U.S. Application Data
(63) Continuation-in-part of application No. 14/985,639, filed on Dec. 31, 2015.

(51) Int. Cl. B60Q 1/32; B60R 3/00; B60Q 1/26; F21V 7/06; F21V 8/00

(52) U.S. Cl. CPC B60Q 1/323; F21V 7/06; G02B 6/0096; B60Q 1/2607; B60R 3/002; B60Q 1/2696; F21Y 2115/10

(57) ABSTRACT

A running board illumination system is provided for a motor vehicle. That system includes a first light pipe having a first end and a second end. A first reflector and first light source are provided at the first end. A second reflector and second light source are provided at the second end. Light emitted from the system is shaped and directed via optical lens to fall upon a running board.

This application is a continuation-in-part of U.S. patent application Ser. No. 14/985,639 filed on Dec. 31, 2015, entitled “Running Board Illumination System and Method for a Motor Vehicle,” the full disclosure of which is incorporated herein by reference.

### TECHNICAL FIELD

This document relates generally to the motor vehicle equipment field and, more particularly, to a new and improved running board illumination system as well as a related method.

### BACKGROUND

The concept of equipping a motor vehicle, such as pickup truck, with deployable running boards beneath the passenger entry doors and bottom side sills is known in the art. Such running boards are maintained in raised, stowed positions while the vehicle is operated at speed and displaced to lowered, deployed positions when: 1) the transmission is in the “park” position, or 2) side doors are opened so that the footpad of the running boards may be utilized to aid individuals to enter and exit the passenger cabin of the motor vehicle.

This document relates to a new and improved running board illumination system and related method providing heretofore unseen functionality and versatility of operation as well as improved opulent, harmonious appearance making it a value-added addition to the motor vehicle.

### SUMMARY

In accordance with the purposes and benefits described herein, a running board illumination system comprises: (a) a first light pipe having a first end and a second end, (b) a first reflector and a first light source at the first end, (c) a second reflector and a second light source at the second end and (d) an optical lens. The optical lens includes optical features whereby light emitted from the running board illumination system is shaped and directed upon a running board.

The first reflector may be a first parabolic reflector. The second reflector may be a second parabolic reflector. The first light source may be a first LED. The second light source may be a second LED. The optical figures may be configured to direct light upon a foot pad surface of the running board.

In accordance with an additional aspect, the running board illumination system comprises a first light pipe having a first end and a second end. A first reflector and a first light source are provided at the first end. A second reflector and a second light source are provided at the second end. The running board illumination system also comprises a second light pipe having a third end and a fourth end. A third reflector and a third light source are provided at the third end. A fourth reflector and a fourth light source are provided at the fourth end. An optical lens includes optical features whereby light emitted from the running board illumination system is shaped and directed upon a running board.

The first reflector, the second reflector, the third reflector and the fourth reflector may all be parabolic reflectors. The first light source, the second light source, the third light source and the fourth light source may all be LEDs. Further, the optical features may be configured to direct the light upon at least one foot pad surface of the running board. Still further, the two light pipes may share a common axis and extend past the ends of the running board.

In accordance with yet another aspect, a method is provided for illuminating a running board of a motor vehicle. That method includes the steps of (a) emitting light from a first light pipe, including a first light source at a first end and a second light source at a second end, and (b) shaping and directing that light upon the running board.

The method may further include the step of emitting additional light from a second light pipe having a third light source at a third end and a fourth light source at a fourth end. Still further the method may include the step of shaping and directing the additional light to fall upon the running board.

The method may also include the step of limiting intensity of the light emitted from the first light pipe so as not to exceed 21 lux when measured one meter above ground. The method may also include the step of limiting the light emitted from the first light pipe and the additional light emitted from the second light pipe so as not to exceed 21 lux when measured one meter above ground.

In the following description, there are shown and described several preferred embodiments of the running board illumination system and the related method. As it should be realized, the system and method are capable of other, different embodiments and their several details are capable of modification in various, obvious aspects all without departing from the system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the running board illumination system and together with the description serve to explain certain principles thereof. In the drawing figures:

FIG. 1 is a detailed, schematic side elevational view of the lamp assembly housing of the running board illumination system including the first illumination element, the second illumination element, the parabolic reflector, the optic lens and the lamp assembly housing that holds those components.

FIG. 2 is a schematic side elevational view illustrating the running board in the lowered, deployed position with light from the first illumination element being directed down upon only the footpad surface of the running board.

FIG. 3 is a view similar to FIG. 2 illustrating the running board in the raised, stowed position with light from the second illumination element being directed through the gap between the bottom of the side sill and the top of the running board.

FIG. 4 is a rear perspective view of the lamp assembly housing illustrating the drainage slots provided in the rearmost flange of that housing.

FIG. 5 is a schematic block diagram of the control circuit of the running board illumination system.

FIG. 6 is a schematic side elevation view of the lamp assembly showing the offset longitudinal axes of the two illumination elements.

FIG. 7 is a schematic illustration of yet another embodiment of running board illumination system comprising a light pipe assembly.

Reference will now be made in detail to the present preferred embodiments of the running board illumination system, examples of which are illustrated in the accompanying drawing figures.

### DETAILED DESCRIPTION

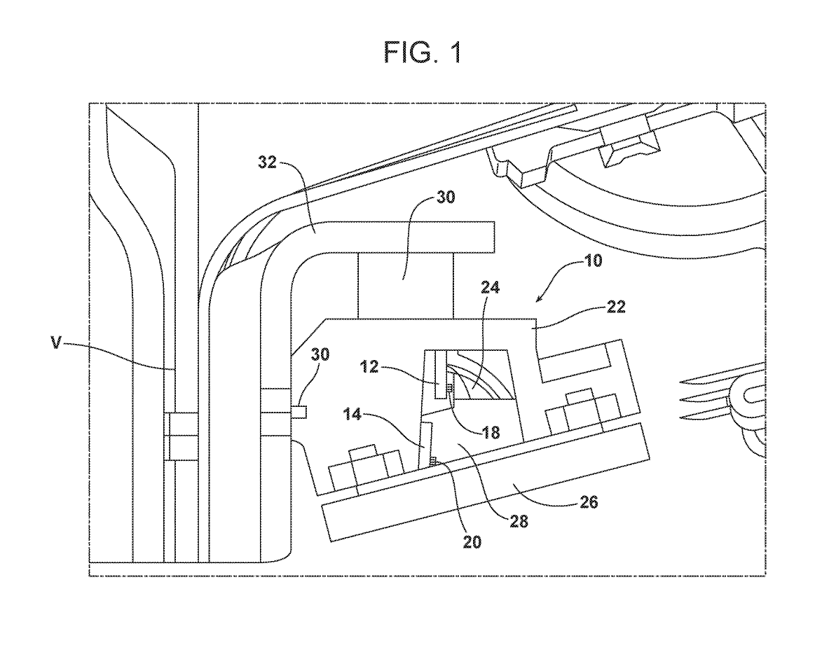

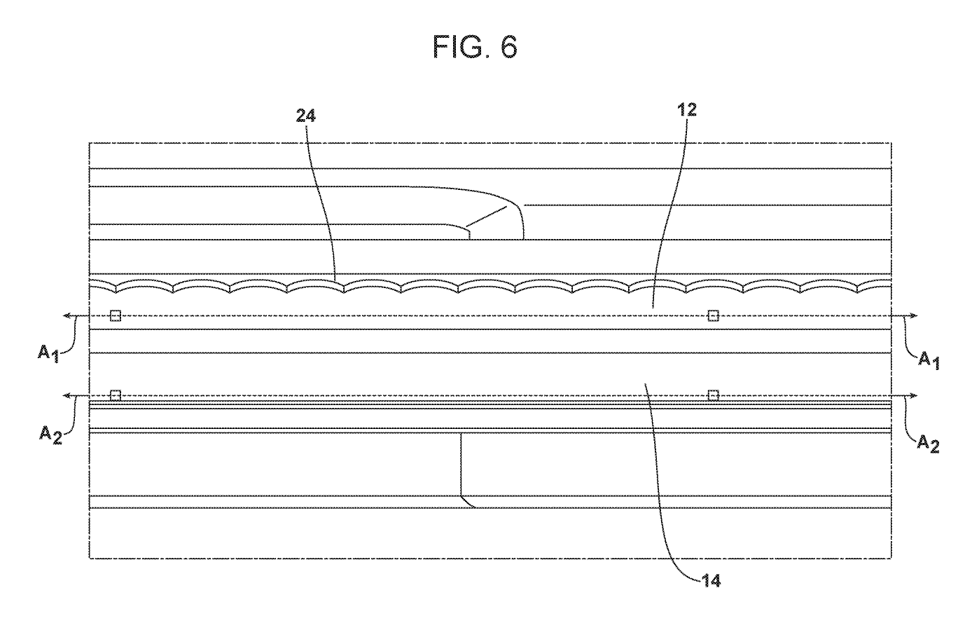

Reference is now made to FIGS. 1-5 illustrating the running board illumination system 10 that is the subject matter of this document. That system 10 includes a first illumination element 12, a second illumination element 14 and a controller 16. In the illustrated embodiment, the first illumination element 12 comprises a first plurality of white light emitting diodes 18 aligned along a first axis A1 running perpendicular to the plane of the drawing figure. The second illumination element 14 comprises a second plurality of amber light emitting diodes 20 aligned along a longitudinal axis A2 again running perpendicular to the plane of the drawing figure. These longitudinal axes A1 and A2 are better illustrated in FIG. 6. As illustrated, the second axis A2 is offset from the first axis A1. Further, the second axis is tilted with respect to the first axis. That tilt may be at an angle of between about 12° and 18° and typically is about 15°. The light emitting diodes 18, 20 may be provided on one or multiple printed circuit boards as desired.

As illustrated, the first illumination element 12 and the second illumination element 14 are carried in the lamp assembly housing 22. A parabolic reflector 24 is held in the housing 22 adjacent to the first illumination element 12. An optically prescribed fluted lens 26 closes the housing 22 providing a sealed interior compartment 28 for the first and second illumination elements 12, 14 and the parabolic reflector 24 so that those components are protected from dust and moisture.

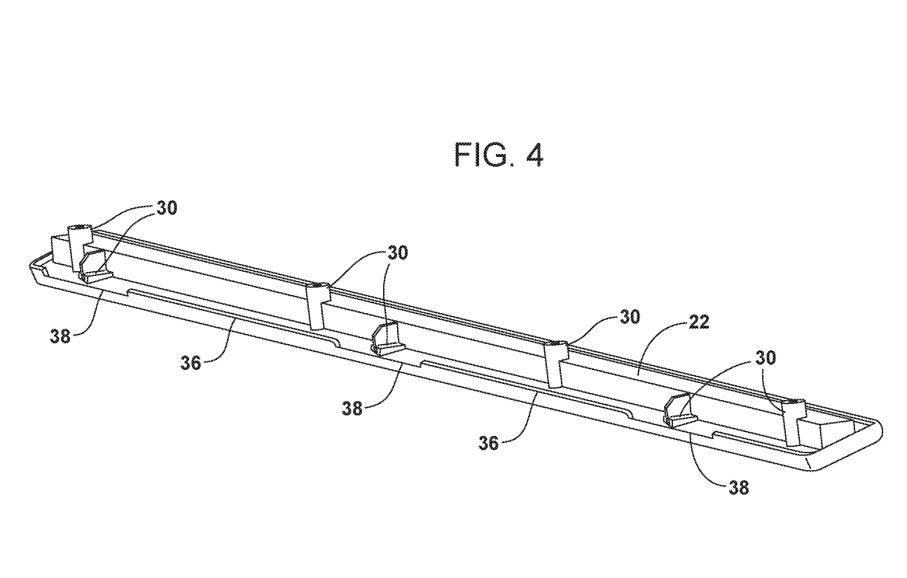

As illustrated in FIGS. 1 and 4, the lamp assembly housing 22 includes a series of mounting bosses 30 for receiving fasteners such as screws (not shown) to mount the lamp assembly housing 22 to the mounting bracket 32. Similarly, the mounting bracket 32 includes bosses 34 for receiving screws or other fasteners to mount the bracket to the motor vehicle V behind/beneath the side sill S. As further shown, the rear flange 36 of the lamp assembly housing 22 includes a series of spaced drainage slots 38 to allow the drainage of water away from the lamp assembly housing 22.

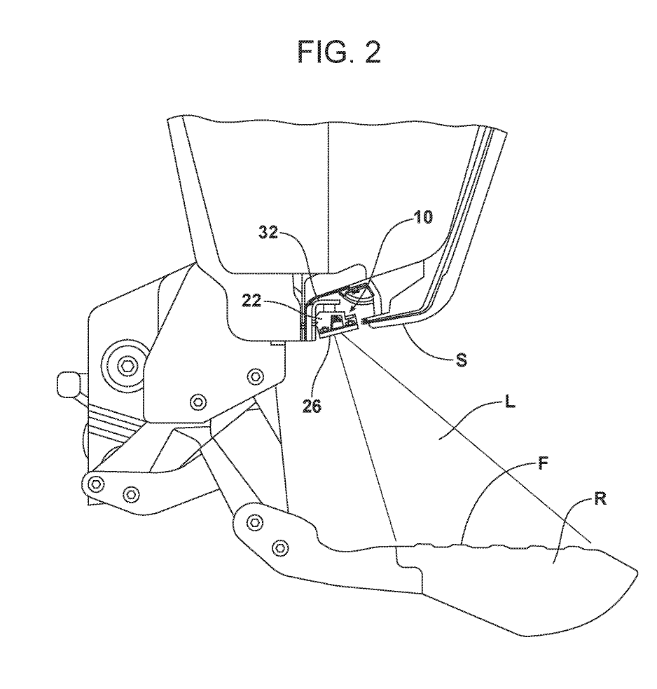

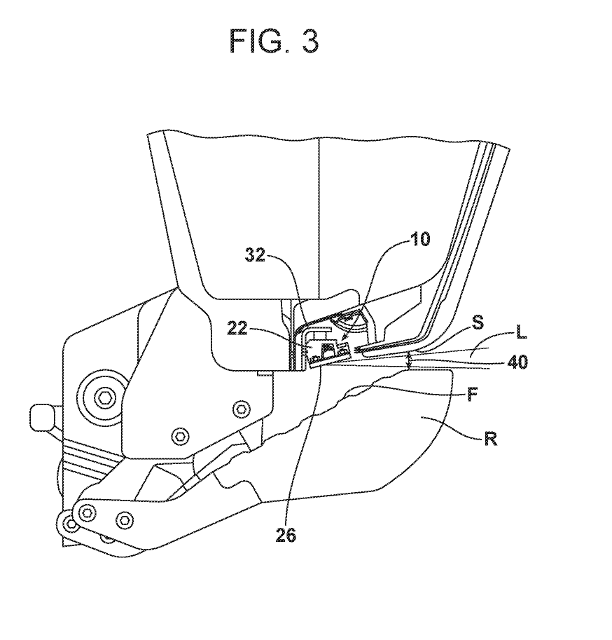

Reference is now made to FIGS. 2 and 3 which illustrate the displaceable running board R of the motor vehicle V in the lowered, deployed position (FIG. 2) and the raised, stowed position (FIG. 3). As illustrated, when the running board R is lowered, the first illumination element 12/first plurality of white LEDs 18 direct white light L through the parabolic reflector 24 and the optic lens 26 downwardly onto only the treaded footpad surface F of the running board so an individual may quickly find and identify that footpad surface for positioning his/her foot to aid in entering the passenger cabin of the motor vehicle V. This white light provides an opulent appearance to the entry/exit activity of the vehicle.

When the motor vehicle V is operated at speed, the running board R is maintained in a raised, stowed position and the second illumination element 14/second plurality of amber LEDs 20 is oriented to direct amber light L through the gap 40 between the top of the running board R and the bottom of the side sill S. See FIG. 3. This amber light L provides an aesthetically pleasing accent to the side of the motor vehicle V.

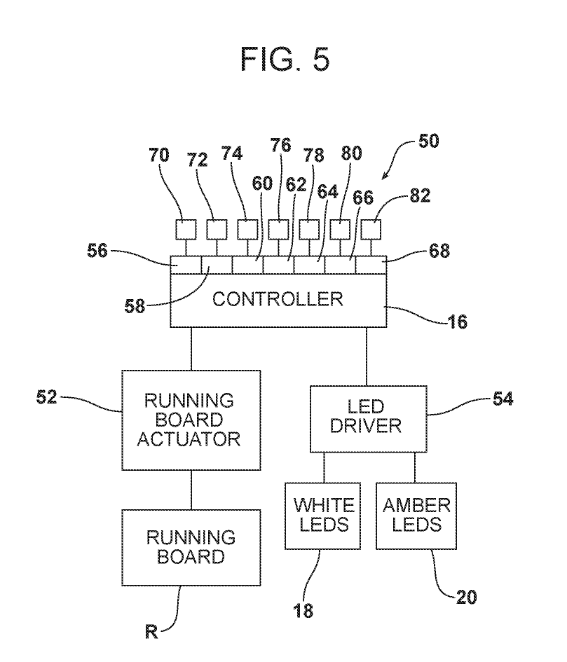

Reference is now made to FIG. 5 illustrating the control circuit 50 for the running board illumination system 10. That control circuit 50 includes the controller 16 which may be connected to a running board actuator 52 for displacing the running board R between the lowered, deployed position illustrated in FIG. 2 and the raised, stowed position illustrated in FIG. 3. Further, the controller 16 may be operatively connected to a single LED driver 54 that may be utilized to drive or power the first and second illumination elements 12, 14/first and second plurality of LEDs 18, 20 where only one of the first or second illumination element/first or second set of LEDs is driven at any one time. This helps to reduce system 10 costs and limit heat sink requirements. Thus, the PCB boards carrying electronic circuitry and LEDs serve as sufficient heat sink.

The controller 16 may be a dedicated microprocessor, a computing device operating specific software instructions or other appropriate electronic control unit (ECU). Thus, the controller 16 may include one or more processors, one or more memories and one or more network interfaces all communicating with each other over a communication bus.

The controller 16 is configured to receive information respecting at least one motor vehicle status and is also adapted to illuminate the running board R with either the first illumination element 12/first plurality of white LEDs 18 or the second illumination element 14/second plurality of amber LEDs 20 based upon that information. Thus, the controller includes various data inputs 56, 58, 60, 62, 64, 66, 68. In the illustrated embodiment, input 56 is connected to a running board position sensor or other device 70 providing data input respecting the position of the running board R. Input 58 is connected to a transmission status sensor or other device 72 providing data respecting the status of the transmission. Input 60 is connected to a speed sensor or other device 74 providing input data respecting the ground speed of the motor vehicle V. Input 62 is connected to a turn signal sensor or other device 76 providing input data respecting the status of the turn signal in the motor vehicle V. Input 64 is connected to an emergency flasher sensor or other device 78 providing input data respecting the status of the emergency flasher of the motor vehicle V.

Input 66 is connected to a light sensor or other device 80 providing input data respecting the ambient light conditions in which the motor vehicle V is being operated. Input 68 is connected to a sensor or other device 82 providing alarm button state data respecting the alarm button on the key fob (not shown) of the motor vehicle V. As will be described in greater detail below, the controller 16 is configured to operate the first illumination element 12/first plurality of white LEDs 18 and second illumination element 14/second plurality of amber LEDs 20 in response to data received at the inputs 56, 58, 60, 62, 64, 66 and 68.

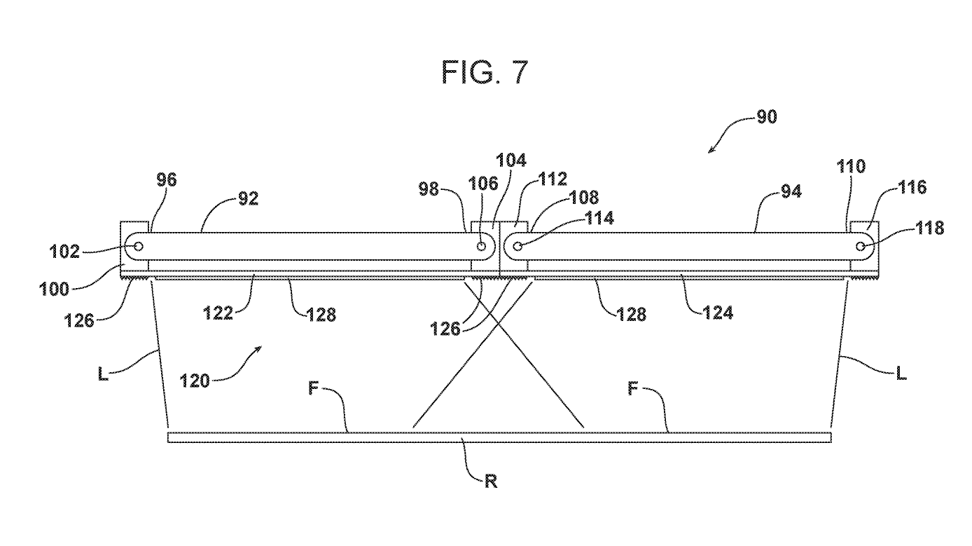

Reference is now made to FIG. 7 illustrating an additional embodiment of the running board illumination system 10 comprising a light pipe assembly 90. The light pipe assembly 90 comprises one or more light pipes extending along the entire length of the motor vehicle to direct light onto a running board in a lowered or deployed position. Specifically, in the embodiment illustrated in FIG. 7, two light pipes 92, 94 running in series extend along a common axis. The first light pipe 92 includes a first end 96 and a second end 98. A first parabolic reflector 100 and a first LED 102 are provided at the first end 96. A second parabolic reflector 104 and a second LED 106 are provided at the second end 98.

The second light pipe 94 includes a third end 108 and a fourth end 110. A third parabolic reflector 112 and a third LED 114 are provided at the third end 108. A fourth parabolic reflector 116 and a fourth LED 118 are provided at the fourth end 110.

The light pipe assembly 90 also includes an outer optical lens 120. In the illustrated embodiment the outer optical lens 120 includes a first section 122 covering the first light pipe 92 and a second section 124 covering the second light pipe 94.

Each of the four parabolic reflectors 100, 104, 112, 116 sends light from respective LEDs 102, 106, 114, 118 down the two light pipes 92, 94. Each parabolic reflector 100, 104, 112, 116 has a respective LED 102, 106, 114, 118 associated therewith, so in the embodiment discussed herein, only four LEDs are used, i.e., one LED at each end of the light pipes 92, 94. Each LED 102, 106, 114, 118 may be provided on one or more printed circuit boards as desired. Advantageously, the reduction in the number of LEDs used in this embodiment results in a significant cost savings without sacrificing light output. Indeed, up to twenty-four (24) LEDs may be used in certain embodiments disclosed herein with respect to the reflector body, but as few as four LEDs may be used in connection with the light pipe assembly 90.

The light pipes 92, 94, as well as the outer optical lens 120, may include optical features such as facets 126 and flutes 128. The unique optical features 126, 128 of the light pipes 92, 94 and outer optical lens 120 work in conjunction to direct light from the respective parabolic reflectors 100, 104, 112, 116 (which may also be faceted) and associated LEDs 102, 106, 114, 118 spreading light L as it is indirectly fired down the axis of the light pipes and refracted based on refractive indexes of a variety of material properties onto the running board R, while minimizing light directed or falling to the ground. The facets 126 and flutes 128 can be of any size and shape in order to achieve a specified illumination performance. In one particularly useful embodiment, the light L is directed upon the running board R in a manner to provide a homogenous light intensity spread evenly across the running board R from end to end.

In other words, the light pipes 92, 94 and lens 120 collimate light to shine only on the step face F of the deployed running board R. The lumen output from the light pipe assembly 90 is limited such that the light measured 1 meter above ground does not exceed 21 lux so that any light falling on the ground (due to any build variations resulting in less than six sigma) does not compete with other lighted features of the vehicle, such as a lighted welcome mat positioned on the ground.

In one particular embodiment, white LEDs 18 are used so that white light is emitted onto the step face F of running board R to allow one to quickly locate that step face and use it as an aid to enter the motor vehicle under lowlight ambient conditions. Specifically, when the running board R is deployed, the light pipe assembly 90 directs white light L through the fluted optic lens 120 downwardly onto the step face F of the running board so an individual may quickly find and identify that step face for positioning his/her foot to aid in entering the passenger cabin of the motor vehicle V. This white light provides an opulent appearance to the entry/exit activity of the vehicle.

Thus, it should be appreciated that a method is provided of illuminating a running board R on a motor vehicle V. That method may be broadly described as equipping the motor vehicle V with a running board illumination system 10 including a first illumination element 12 having a first color, a second illumination element 14 having a second color and a controller 16. The method includes selectively illuminating the running board R with light emitted by the first illumination element 12 when the running board is in a lowered, deployed position as illustrated in FIG. 2 and selectively illuminating the running board with light emitted by the second illumination element 14 when the running board is in a raised, stowed position as illustrated in FIG. 3. Thus, the method includes activating the first illumination element 12 or second illumination element 14 depending on data received from the position sensor 70 through the data input 56.

In another embodiment, the method includes the controller 16 receiving information respecting transmission state and vehicle speed from the sensors or devices 72, 74 through the inputs 58, 60. In this embodiment, the first illumination element 12 is activated by the controller 16 when (a) the transmission is in park or the transmission is shifted into gear from park but remains stationary (ground speed is zero) and (b) the running board R is in the lowered, deployed position illustrated in FIG. 2 so as to illuminate the step face F. In contrast, the second illumination element 14 is activated by the controller 16 when the transmission is in gear and ground speed is other than zero and the running board R is in the raised, stowed position illustrated in FIG. 3 so as to provide accent lighting through the gap 40 between the side sill S and the top of the running board R.

In yet another embodiment, the method includes operating or activating, by the controller 16, the second illumination element 14 as a redundant turn signal. In one possible embodiment, the method may also include alternating, by the controller 16, the redundant turn signal of the second illumination element 14 with the main turn signal of the motor vehicle V. In yet another embodiment, the second illumination element includes multiple groups of amber LEDs 20 extending longitudinally along the vehicle above the running board R and the controller 16 operates or activates the second illumination element 14 so as to provide a sequential turn signal from the forwardmost group to the rearwardmost group or from rearwardmost group to the forwardmost group.

In yet another embodiment, the method includes operating or activating, by the controller 16, the second illumination element 14 as a redundant emergency flasher. In one possible embodiment, the controller 16 operates the redundant emergency flasher of the second illumination element 14 so that it alternates with the main emergency flasher of the motor vehicle V. Such redundant operation helps attract the attention of others.

In yet another possible embodiment, the method includes flashing, by the controller 16, both the first illumination element 12 and the second illumination element 14 when the running board R is being displaced from the raised, stowed position illustrated in FIG. 3 to the lowered, deployed position illustrated in FIG. 2. In yet another embodiment, the method includes varying, by the controller 16, the light intensity of the first illumination element 12 and/or the second illumination element 14 based upon the ambient light conditions as detected by the ambient light sensor 80 and provided to the controller input 66.

In still another embodiment, the method includes varying, by the controller 16, the light intensity of the first illumination element 12 and/or the second illumination element 14 based upon an alarm button state on the motor vehicle key fob as detected by the alarm button sensor/detector 82 and provided to the controller input 68. In summary, a running board illumination system 10 and related method provide a number of benefits and advantages that make them value added features for a motor vehicle. During operation of the vehicle at speed, the amber light emitted by the second illumination element 14/second plurality of amber LEDs 20 through the gap 40 between the side sill S and the raised running board R provides distinctive and aesthetically pleasing accent lighting. As noted, that lighting feature may be made redundant to the emergency flashers and the turn signals of the vehicle if desired. In contrast, when the motor vehicle is placed in park, the controller 16 deactivates the second illumination element 14/second plurality of amber LEDs 20 and activates the first illumination element 12/first plurality of white LEDs 18 so that white light is emitted onto the step face F of running board R to allow one to quickly locate that step face and use it as an aid to enter the motor vehicle under lowlight ambient conditions. Significantly, the system may also be configured to maintain the white light from the first illumination element 12/first plurality of white LEDs 18 on only the footpad surface F when the vehicle is shifted into reverse or forward speed so long as the ground speed of the motor vehicle based upon data provided to the ground speed input 60 is zero. Thus, should the vehicle operator place the transmission in a forward or reverse gear prior to entry of the passenger into the motor vehicle, the first illumination element 12/first plurality of white LEDs 18 continues to emit white light on only the footpad surface F of the running board R beneath the passenger door to aid the passenger in finding the running board R and entering the vehicle. The white light provides an opulent appearance. Once the ground speed of the vehicle indicates movement in either a forward or reverse direction, the controller 16 extinguishes the first illumination element 12/first plurality white LEDs 18 and energizes or activates the second illumination element 14/second plurality of amber LEDs 20 to provide accent lighting for the running board R which may be automatically raised by the controller controlled actuator 52 into the stowed position when the motor vehicle V is put into motion.

Still further, the running board illumination system 10 provides an additional feature to help an operator find the vehicle in a dark, crowded parking lot. More specifically, when an operator depresses the alarm /search button on the key fob of the motor vehicle V, the controller 16 will cause the running board R to be lowered through the running board actuator 52. Simultaneously, the first and second illumination elements 12, 14/first and second plurality of amber LEDs 18, 20 will pulse to provide alternate, flashing white and amber lighting adjacent the running board R. This pulse may be at three times the current so as to provide approximately six times the light output normally provided by the elements 12, 14/LEDs 18, 20 so that the flashing is more effective in drawing attention to the vehicle.

The foregoing has been presented for purposes of illustration and description. It is not intended to be exhaustive or to limit the embodiments to the precise form disclosed. Obvious modifications and variations are possible in light of the above teachings. For example, the controller 16 may also function to control the intensity of the light emitted by the first illumination element 12/first plurality of white LEDs 18 and second illumination element 14/second plurality of amber LEDs 20 as desired. Thus, for example, the light intensity may be increased to a maximum over three seconds as the running board R is deployed from the raised, stowed position illustrated in FIG. 3 to the lowered, deployed position illustrated in FIG. 2. Similarly, the light intensity may be decreased to shut off as the running board R is displaced from the lowered, deployed position to the raised, stowed position over a span of five seconds. In other embodiments light with colors other than white and amber may be used. LEDs that change color may also be employed if desired. Further, chrome or white accent stripes may be provided on the surfaces of the side sill S and running board R identified at the double arrow 40 where they will function as reflectors to enhance light output through the gap 40. All such modifications and variations are within the scope of the appended claims when interpreted in accordance with the breadth to which they are fairly, legally and equitably entitled.

What is claimed:

1. A running board illumination system, comprising:
a first light pipe having a first end and a second end;
a first reflector and a first light source at said first end;
a second reflector and a second light source at said second end; and
an optical lens including optical features whereby light emitted from said running board illumination system is shaped and directed upon a running board.

2. The running board illumination system of claim 1 wherein said first reflector is a first parabolic reflector.

3. The running board illumination system of claim 2, wherein said second reflector is a second parabolic reflector.

4. The running board illumination system of claim 3, wherein said first light source is a first LED.

5. The running board illumination system of claim 4, wherein said second light source is a second LED.

6. The running board illumination system of claim 5, wherein said optical features are configured to direct said light upon a foot pad surface of said running board.

7. A running board illumination system, comprising:
a first light pipe having a first end and a second end;
a first reflector and a first light source at said first end;
a second reflector and a second light source at said second end;
a second light pipe having a third end and a fourth end;
a third reflector and a third light source at said third end;
a fourth reflector and a fourth light source at said fourth end; and
an optical lens including optical features whereby light emitted from said running board illumination system is shaped and directed upon a running board.

8. The running board illumination system of claim 7 wherein said first reflector, said second reflector, said third reflector and said fourth reflector are parabolic reflectors.

9. The running board illumination system of claim 8 wherein said first light source, said second light source, said third light source and said fourth light source are LEDs.

10. The running board illumination system of claim 9, wherein said optical features are configured to direct said light upon at least one foot pad surface of said running board.

11. The running board illumination system of claim 7, wherein said first light source, said second light source, said third light source and said fourth light source are LEDs.

12. The running board illumination system of claim 7, wherein said first light pipe and said second light pipe share a common axis.

13. A method of illuminating a running board of a motor vehicle, comprising:
emitting light from a first light pipe including a first light source at a first end and a second light source at a second end; and
shaping and directing said light to fall upon said running board.

14. The method of claim 13, further including emitting additional light from a second light pipe including a third light source at a third end and a fourth light source at a fourth end.

15. The method of claim 14, further including shaping and directing said additional light to fall upon said running board.

16. The method of claim 15, further including limiting intensity of said light and said additional light emitted so as not to exceed 21 lux when measured 1 meter above ground.

17. The method of claim 13, further including limiting intensity of light emitted from said first light pipe so as not to exceed 21 lux when measured 1 meter above ground.
